(19) United States
(12) Patent Application Publication
(10) Pub. No.: US 2014/0344854 A1
(43) Pub. Date: Nov. 20, 2014

(54) Method and System for Displaying Speech to Text Converted Audio with Streaming Video Content Data

(71) Applicant: Aereo, Inc., New York, NY (US)

(72) Inventors: Chaitanya Kanojia, West Newton, MA (US); William Griffin Cherry, Roslindale, MA (US)

(21) Appl. No.: 14/279,530

(22) Filed: May 16, 2014

Related U.S. Application Data
(60) Provisional application No. 61/824,690, filed on May 17, 2013.

(51) Int. Cl. H04N 21/4402; H04N 21/472; H04N 21/488; H04N 21/234; H04N 21/2343; H04N 7/173; H04N 21/6405

(52) U.S. Cl. CPC H04N 21/440236; H04N 7/17318; H04N 21/47202; H04N 21/6405; H04N 21/234; H04N 21/234336; H04N 21/4882
USPC 725/34; 725/97

(57) ABSTRACT

A cloud based video delivery system along with a method and graphical user interface for streaming synchronized video content data to a group of user devices are disclosed. The user devices of the group receive speech to text converted audio (or speech-to-text communications) generated by the different users of their group along with the streaming video content data from the cloud based video delivery system. The speech to text communication and streaming video content data are then displayed on the user devices of the users in a synchronized fashion.

### RELATED APPLICATIONS

This application claims the benefit under 35 USC 119(e) of U.S. Provisional Application No. 61/824,690, filed on May 17, 2013, which is incorporated herein by reference in its entirety.

### BACKGROUND OF THE INVENTION

In general, cloud based video delivery systems provide content such as television programs, movies, or user generated video to users via data networks such the Internet and/or private networks such as service/access provider or cellular data networks. Users typically access the cloud systems by invoking dedicated applications on their user devices or using general purpose browsers to navigate to websites of the cloud systems. After invoking the applications or navigating to the websites, graphical user interfaces (GUI) are displayed on the user devices that enable the users to access the content.

Currently, well-known cloud based video delivery systems are provided by companies such as HULU, LLC, Netflix, Inc., and YouTube, LLC, to list a few examples. While there is often overlap in the content provided, the different systems generally serve different consumer needs. HULU, LLC, for example, typically offers third party content such as recently-aired television programs after those programs have been first broadcast by broadcasting entities such as the major television networks. Netflix, Inc. offers its users third party content such as movies, television programs, and documentaries, for example, that have been released on DVD as well as content created specifically for Netflix, Inc. and/or Internet broadcast (webisodes). Lastly, the YouTube, LLC website allows users to view and share third party content, user-generated video, video logs (video blogs or vlog), and instructional videos, to list a few examples.

Recently, a cloud based video delivery system has been developed that permits users to capture over the air broadcast content from the broadcasting entities such as the major television networks. Upon receiving a request from a subscriber, this cloud based video delivery responds to the request by tuning a specific user-assigned antenna element to capture the over the air content broadcast by the broadcasting entities. The captured content is then decoded and stored by the cloud system or streamed to the user device of that user.

Some of these video delivery systems have developed frameworks for social viewing of streaming content. Social viewing of streaming content allows users of a group, for example, to view the same video content on their different user devices. One such implementation of social viewing was Netflix's Party Mode on the Xbox game console (Xbox) by Microsoft Corporation. Party Mode enabled users with Netflix Instant subscriptions and Xbox Live subscriptions to view content from Netflix, Inc. as a group via their respective Xbox game consoles. Additionally, the users of the group were able communicate with the other users in their group with messaging, chat, and parties features of Xbox Live.

In general, the messaging, chat, and parties features of Xbox Live provide several different methods to communicate with other users. For example, users can use headsets to communicate verbally or keyboards to create written message communications. More recently, British Sky Broadcasting Group (known as BskyB) has developed an application for social viewing via Xbox known as SkyTV. The users are represented by avatars that interact in a virtual living room, which includes one or more virtual television screens. The users in the same virtual living room are able to view the content displayed on the virtual television screen of the room. Similar to Netflix's Party Mode on the Xbox game console, the users in the virtual living room are able to communicate via the messaging, chat and parties features of Xbox Live.

### SUMMARY OF THE INVENTION

According to one aspect, the present invention is directed to a cloud based video delivery system that streams video content data to a group of user devices to enable social video viewing by the users. Of these devices, one is designated the controlling device and is able to control the streaming (or realtime) video content data for all of the user devices of the group. Commands (e.g., pause, stop, skip forward/back) input at the controlling device are applied the video content displayed on the other user devices of the group. This ensures that the users of the group are watching the same video content data, and that its playback is synchronized among the group.

In general, according to this aspect, the invention features a cloud based video delivery system for streaming video content data to a group of users. The system includes a streaming server system, which receives commands from a controlling user device for the group of users and then synchronizes the video content data streamed to other users within the group in response to the received commands. The system further includes user devices that display the video content data received from the streaming server system.

When characterized as a method, the invention features a method for streaming video content data to group of users. The method includes receiving commands from a controlling user device for the group of users, synchronizing the video content data steamed to other users within the group in response to the received commands, and displaying the synchronized video content data on user devices of the group of users.

According to another aspect, one problem with existing cloud based video systems is the limited number of ways in which users in a group can communicate with each other. For example, any of the users in the group are able to talk as much as they want and multiple users are able to talk simultaneously. Thus, users are forced to choose between hearing numerous conversations from different users all at once, ignoring/blocking all the users, or relying on ponderous messaging.

To address this, the present invention provides an option for users to receive speech to text converted audio that is generated for the different users of their group and receive that text along with the streaming video content data. In this way, each user is able to monitor (or ignore) what other users are saying and still hear the audio from the streaming video content data. Additionally, if users wish to communicate with one or more users of their group, then connections can be opened to allow users to hear the audio generated by other users.

In general, according to this other aspect, the invention features a system for displaying intra-group communications and streaming video content data. The system comprises user devices for displaying the video content data along with speech-to-text communications. Additionally, each user device includes a microphone to detect audio generated by users. The system further includes a streaming server system that streams the video content data to the user devices and an intra-group system that distributes the speech-to-text communications generated from the audio detected by the microphones between the user devices that are within a group.

When characterized as a method, the invention features a method for displaying intra-group communications and streaming video content data. The method further includes detecting audio generated by users with microphones, converting the detected audio into speech-to-text communications, and distributing the speech-to-text communications generated from the audio detected by the microphones between the user devices that are within a group. The method further includes streaming the video content data to the user devices that are within a group and displaying the video content data along with speech-to-text communications on user devices.

Another problem with existing systems is that they are often ineffective at scheduling when to watch video programs for the groups. In many cases, this is because it is difficult for groups of users to decide what to watch and/or at what time they should watch it.

To address this problem, users are able to create groups and then assign specific video programs, timeslots, or open-ended timeslots to those groups. This allows users to agree to watch specific video programs or set a time (e.g., Thursday at 7:00 pm) and then decide what they want to watch, i.e., agree to an general window of time, for example.

In general, according to this aspect, the invention features a method for organizing user devices into groups to watch video programs. The method comprises enabling controlling users to create respective groups of users, assign video programs and/or timeslot to their respective groups, and display of video content data for the video programs on the devices of the users within their respective groups.

In still another aspect, the present invention includes a graphical user interface (GUI) displayed on the user devices. The GUI includes a video portion to display the streaming video content data and the speech to text converted audio generated by the different users of their group. The GUI further includes a user group portion that displays a selectable list of users. Selection of a user enables the selecting user to hear audio of the selected user.

In general, according to yet another aspect, the invention features a graphical user interface displayed on a user device of a cloud based video delivery system. The graphical user interface comprises a video portion of the graphical user interface in which streaming video content data are displayed by the user devices, a user group portion that displays a list of users with in a group, and a speech to text portion that displays speech to text converted audio of the users within the group.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram illustrating a cloud based video delivery system, user devices, and a group of users organized for social viewing of streaming video content data.

FIG. 2 is a schematic diagram illustrating an example of the database architecture for storing user group information in the business management system.

FIG. 3 is a flowchart illustrating the steps for organizing users into a group and sending reminder messages to the group prior to the start of the social viewing.

FIGS. 4A and 4B illustrate an example of a graphical user interface that updates statuses of users in the group as they log into the cloud system.

FIG. 5 is a flowchart illustrating how the cloud system synchronizes the playing of video content data, which was captured by antenna elements, on the user devices of the group.

FIG. 6 is a flowchart illustrating how the cloud system synchronizes the playback of separate copies of previously recorded video content data on the user devices of the group.

FIG. 7 is a flowchart illustrating how the cloud system synchronizes the playback of the organizing subscriber's previously recorded video content data on the user devices of the group.

FIG. 8 is a flowchart illustrating how the cloud system synchronizes the playback of video content data derived from a single source such as third party content on the user devices of the group.

FIG. 9A illustrates an example of the graphical user interface displayed on the user device of the organizing subscriber of the group of users.

FIG. 9B illustrates an example of the graphical user interface displayed on the user device of the other users of the group.

FIG. 9C illustrates an example of the graphical user interface displayed on the user device of users when the user device has opened an audio connection with another user device of the group.

FIG. 9D illustrates an example of a graphical user interface displayed on the user device of the users of the group when other users of the group have opened the audio connection each other.

FIG. 10 is a schematic diagram illustrating the cloud based video delivery system and the conversion of audio (speech) generated by the users into text communications for distribution by the intra-group communication system.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms including the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

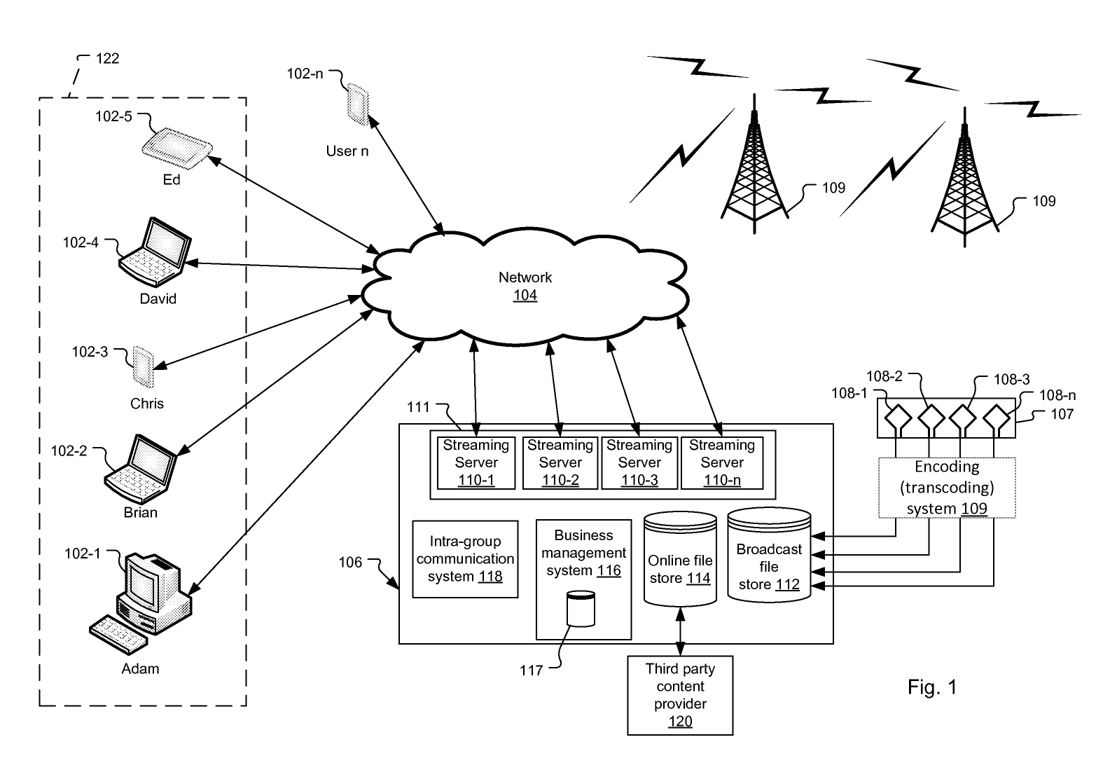

FIG. 1 is a block diagram illustrating a cloud based video delivery system 106, user devices 101-2 to 102-n, and a group 122 of users (Adam, Brian, Chris, David, and Ed) organized for social viewing of video content data.

In the illustrated example, the user devices include a personal desktop computer 102-1 (Adam), laptop computers 102-2 (Brian), 102-4 (David), a tablet (or slate) mobile computing device 102-5 (Ed), and smartphone mobile computing devices 102-3 (Chris), 102-n (User n). Additionally, the user devices could also include devices such as game consoles, or televisions which typically have Internet connectivity and provide web browsing capabilities or televisions with set top boxes (STB) or network appliance and entertainment devices such as the AppleTV device, Google Chromecast Dongle, or the Amazon-Fire TV device, to list a few contemporary examples.

Some of the users are organized into different and possibly overlapping groups such as a group 122 for social viewing, which allows users in the same group to view synchronized video content data on separate user devices 102-1 to 102-n. Typically, the users are in different physical locations when organized for the social viewing, but the users could be in the same building or even in the same room, in some examples.

In a preferred embodiment, there is no limit on to how many groups the users can be in simultaneously. In alternative embodiments, however, restrictions are placed on the number of groups users can be in as part of subscription tiers or to simply limit the numbers of groups associated with each user, for example. These settings are dictated by the business rules stored in a business management system 116.

The user devices 102-1 to 102-n connect to the cloud system 106 via network 104. Typically, the network 104 implements the internet protocols and often includes segments extending over one or more of: an enterprise network, service or access provider network, a home (or local) area network, or a public and/or private Wi-Fi network, to list a few examples. In some instances, the network further includes a segment on a mobile cellular data network (e.g., third or fourth generation mobile broadband networks).

The cloud based video delivery system 106 delivers streaming video content data to the user devices 102-1 to 102-n. In a typical implementation, the cloud system 106 is a subscription-based service. However, the cloud system 106 could also be a free service or an ad-supported service, in other implementations.

In the illustrated example, the cloud system 106 is shown as a single centralized system. In operation, the cloud system 106 is generally divided among several different systems deployed in different geographical locations and connected via networks and/or subnetworks. In some examples, the system further includes content delivery networks for facilitating the delivery of the content video data to the user devices 101-2 to 102-n.

The cloud system 106 includes a streaming server system 111, which is comprised of a set of streaming servers 110-1 to 110-n, in one implementation. In one embodiment, the streaming servers 110-1 to 110-n are separate devices of the server system 111. Alternatively, the streaming servers 110-1 to 110-n could be different virtual servers running on one or more hardware devices and/or geographically distributed.

In operation, the streaming servers 110-1 to 110-n temporarily store and/or buffer the video content data before streaming it to the user devices 102-1 to 102-n, where it is also buffered. This buffering allows user devices 102-1 to 102-n to be able to, for example, pause, skip, and replay the video content data and also compensates for delays in the network 104 or within the cloud system 106.

In a preferred embodiment, the video content data are sent to user devices 102-1 to 102-n via UDP (user datagram protocol), which is a stateless, streaming protocol. In general, UDP is a simple transmission model that provides less reliable service because messages (datagrams) may arrive out of order, be duplicated, or be dropped. However, this protocol is preferred for time-sensitive transmission, such as streaming video, because the protocol does not wait for dropped or missing packets to be resent.

The business management system 116 of the cloud system 106 verifies the accounts of users and/or helps users create new accounts if they do not yet have one. Additionally, the business management system 116 stores user account and user group information in a business management database 117.

An intra-group communication system 118 of the cloud system generates speech to text communications from audio generated by the users on their respective user devices 102-1 to 102-n. The intra-group communication system 118 then distributes the speech to text communications to the user devices 102-1 to 102-n in the group 122.

In one embodiment, the video content data are over the air broadcasts such as television programs that are captured from broadcasting entities 109 such as the major television networks. Some example of well-known broadcasting entities include The American Broadcasting Company (ABC), The National Broadcasting Company (NBC), FOX broadcasting company, and CBS broadcasting corporation (CBS).

The over the air broadcasts are captured by antenna elements 108-1 to 108-n of an antenna array 107. Each antenna element 108-1 to 108-n is separately tunable to allow the antenna elements to be able to capture over the air broadcasts from the different broadcasting entities 109 under the control of the users (e.g., Adam, Brian, Chris, David, and Ed) in one embodiment. In one embodiment, each antenna element is allocated to only a single user and thus captures only over the air broadcasts for that user. This allocation can be permanent, semi-permanent or only temporary, until the element is allocated possibly to another user.

In other examples, the over the air broadcasts are received from the broadcasting entities view data feeds or satellite feeds.

The captured or otherwise received over the air broadcasts are then encoded such as transcoded from MPEG2 encoding, which is currently a standard format for the coding of moving pictures and associated audio information, to MPEG4, for example, that is more efficient for storage and streaming. The transcoded content data are then stored in the broadcast file store 112 and/or streamed to the users as realtime video content data. An example of a system for capturing and streaming over the air content to users is described in, “System and Method for Providing Network Access to Antenna Feeds” by Kanojia et al., filed Nov. 17, 2011, U.S. patent application Ser. No. 13/299,186 (U.S. Patent Application Publication Number: US 2012/0127374 A1), which is incorporated herein by reference in its entirety.

Another source of the video content data is an online file store 114, which stores or accesses video content data from third-party content providers 120 such as on-demand movie services, on demand television programs, and/or file hosting websites for user generated content, to list a few examples. Nevertheless, in still other implementations, the antenna system is not provided and only third-party content is streamed such as the case with HULU, LLC, Netflix, Inc., and YouTube, LLC.

In a typical implementation, some groups will be receiving video content data captured by the antenna system 107 and other groups will be receiving content from third-party content providers 120.

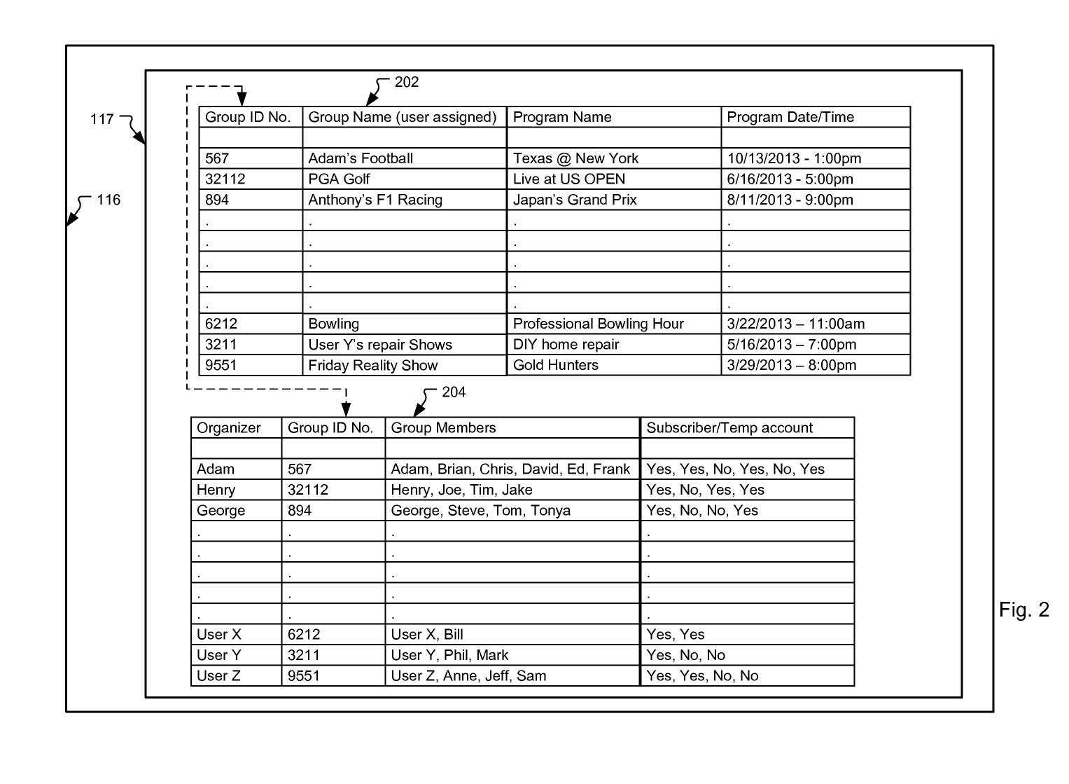

FIG. 2 illustrates an example of the database architecture for storing user group information in the business management database 117.

In a typical implementation, the business management database 117 is organized as a relational database, which is a way of storing information as a series of interconnected tables. The tables are connected with a primary key, which is a column of information that is identical in at least two of the tables.

In the illustrated example, the primary key between the first and second tables 202, 204 is stored in the group identification number column which is used as the index. This column is the primary because new and unique group identification numbers are generated whenever a new group is created.

Referring to the first table 202, the Group ID No. column holds each group's unique identification number, which is generated by the cloud system 106 whenever a new group is created. The Group Name column holds the name assigned to the groups. Typically, the group name is assigned by an organizing subscriber, but could be assigned by any member of the group. The Program Name column identifies the one or more video programs that have been assigned to the group and the Program Date/Time field identifies a timeslot of when the assigned video program is scheduled to air.

In some situations, programs do not have fixed broadcast times. In one example, sports teams often play at different times each day/week. In these scenarios, the fields in the Program Date/Time column may be empty and/or they may be updated to reflect the changing timeslots of assigned video program.

In other situations, the users may decide to create a group for social viewing of video content data, but the group has yet to decide what to watch. In this situation, the Program Name field would not have data until the users select a video program. Alternatively, the Program Name field may be left blank. Nevertheless, the group may have agreed on a time to watch a program so the field in the program date/time column would include that agreed time.

Referring to the second table 204, the Organizer column 204 identifies the organizing subscriber. The organizer is the user that created the group and has a subscription to the cloud system 106, in most embodiments. The Group Members column contains a list of the users in the group and the Subscriber/Temp Account column identifies which of the group's users have an account with the cloud system 106. While the illustrated embodiment shows comma separated values in the Group Member and Subscriber/Temp Account, the information in these fields could be organized as subtables and connected to the first and/or second tables 202, 204.

While the illustrated example only shows two tables for the purposes of illustrating the type of information that the business management system 116 tracks, a typical implementation includes additional related tables holding other information about the users such as account information, personal information, contact information, billing information, usernames, and/or passwords, to list a few examples. Moreover, a different table architecture could be used.

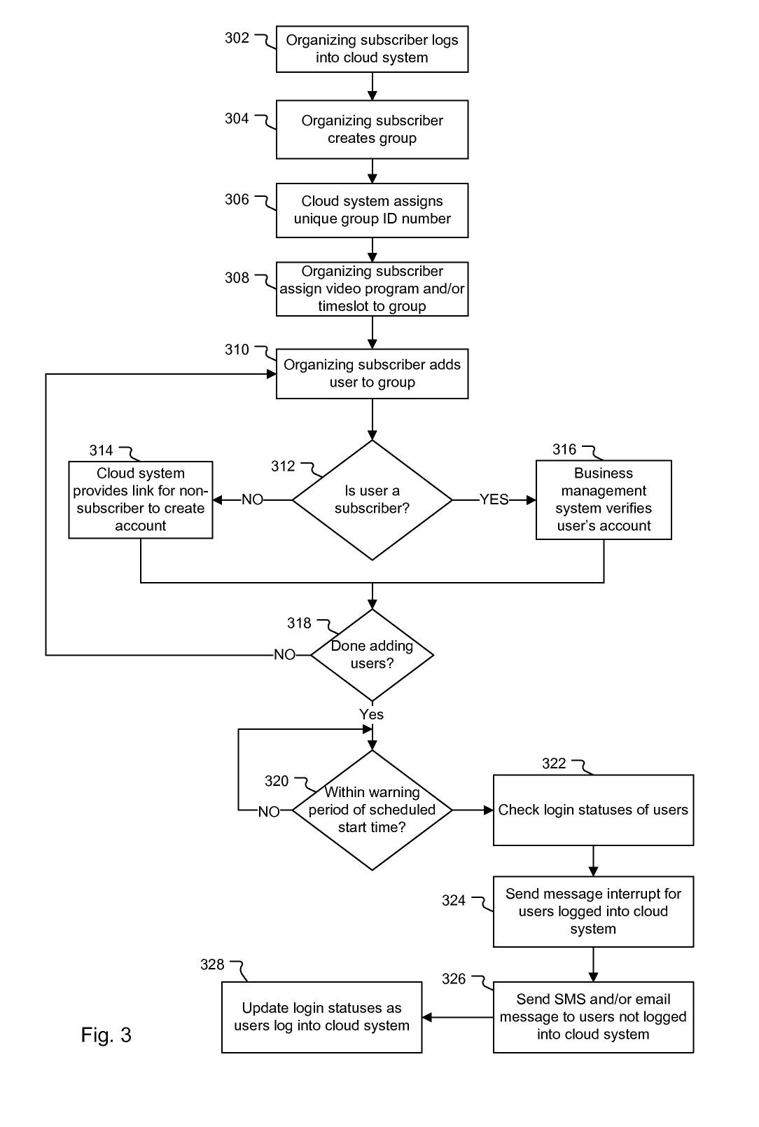

FIG. 3 is a flowchart illustrating the steps for organizing users into a group and sending reminder messages to the group prior to the start of the social viewing. This system for sending out reminders allows the cloud system 106 to facilitate group formation and the attendance of the members of the group.

The organizing subscriber logs into the cloud system 106 in step 302 and then creates a group in step 304 such as by assigning its name. In the next step 306, the cloud system 106 assigns a new a unique group identification number to the group. Next, the organizing subscriber assigns a program and/or timeslot to the group in step 308. In an alternative embodiment, the organizing user is able to assign multiple programs and/or timeslots to the group or programs in a series that occupies a specific timeslot week to week. In still other examples, the organizing subscriber is not forced to assign a specific program and/or timeslot to the group but is simply allowed to form the group and then later assign these further attributes to it.

Typically, the organizing subscriber assigns a specific video program to the group and the assigned video program includes an inherent timeslot associated with the assigned video program. Alternatively, the organizing subscriber is also able to assign a timeslot (e.g., a scheduled time and date) to the group but not necessarily a specific program or channel. This enables users to agree to watch video program as a group as a specific time, and then later decide what to watch.

In yet another embodiment, the organizing subscriber assigns an open-ended timeslot such as “Friday evening” or “Sunday Afternoon.” In many situations, it is not possible for all the users of the group all be available at the same time. This option allows the users of the group to agree on a large window of time on specific day, but with no defined start or end times.

In the next step 310, the organizing subscriber adds a user to the group. The cloud system 106 then determines if the user is a subscriber in step 312. In one embodiment, the cloud system provides a hyperlink that directs users to an account verification page that allows the user to provide their account information. In an alternative embodiment, the organizing user provides the added user's name (or username), which the cloud system 106 compares against a record of all subscribers and then assigns that user to the group.

If the user is a subscriber, then the business management system 116 of the cloud system 106 verifies the user's account information in step 316 and adds the user. On the other hand, if the user is not a subscriber of the cloud system 106, then the cloud system provides a hyperlink that directs the non-subscribing user to create an account. The user is able to create a subscriber account, which provides unlimited access to the cloud system 106 or temporary account, which provides limited access.

Next, in step 318, the cloud system 106 determines if the organizing subscriber is done adding users to the group. If the organizing subscriber is not done adding users, then the organizing subscriber continues to add users to the group in step 310.

The cloud system then enters a wait state with respect to this group in which the cloud system 106 determines if the current time is within a warning period prior of the scheduled start time of the assigned video program or the start time for video viewing by the group in step 330. In a typical implementation, the warning period is simply a predefined defined amount of time prior to the start of the assigned video program and/or timeslot.

When within warning period, the cloud system 106 checks the login status of the users of the group in step 322. The cloud system 106 then sends message interrupts in step 324 to the users logged into the cloud system 106 to notify them that the timeslot for their group is approaching. In one example, the cloud system also sends SMS (short message service) messages via a cellular data network, chat messages and/or electronic mail messages to users of the group that are not logged into the system in step 326 to notify them of the approaching timeslot for their group. Lastly, the cloud system updates statuses of users as they log into the cloud system 106 in step 328.

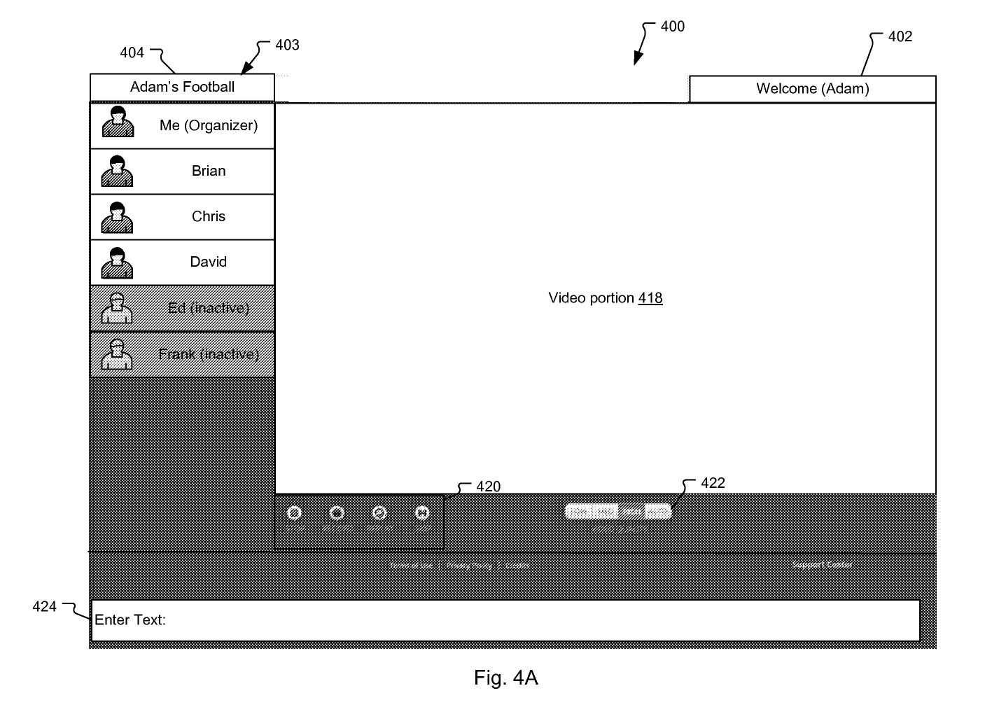

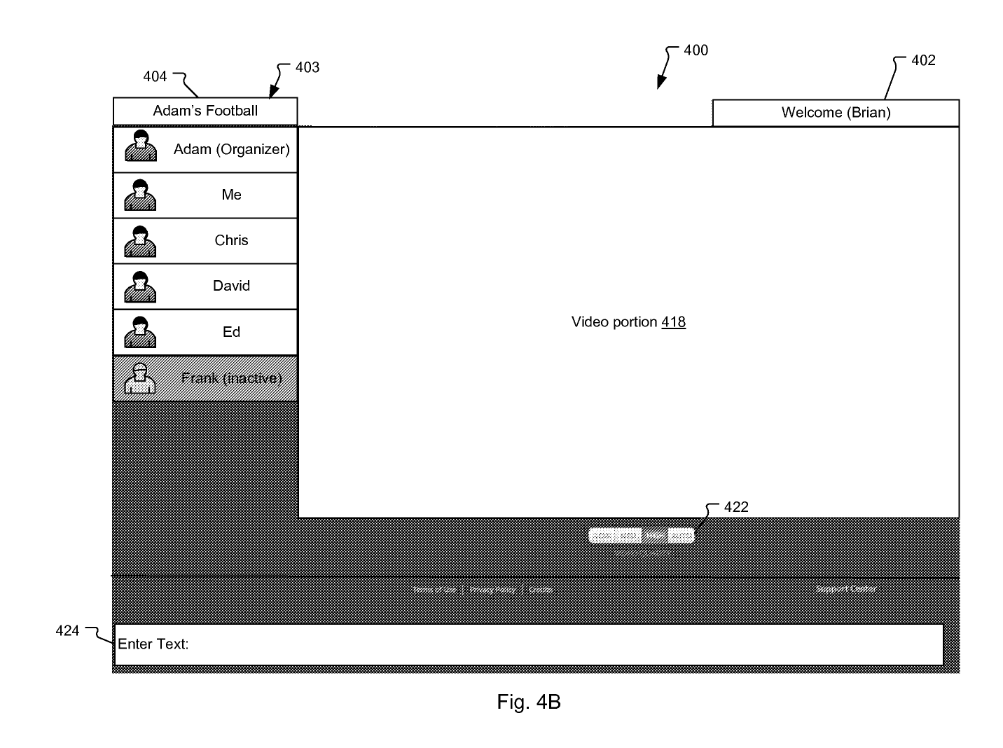

FIGS. 4A and 4B illustrate an example of a graphical user interface (GUI) 400 that is displayed on the user devices 102 for the cloud system 106. It illustrates how the login status of the users within the group is portrayed to those users that are logged in.

In the illustrated example, the GUI 400 updates statuses of users (Adam, Brian, Chris, David, and Ed) as they log into the cloud system 106.

Referring to FIG. 4A, the GUI 400 includes a video portion 418 for displaying video content data on the user devices 102-1 to 102-n that is transmitted to the user devices 102 by the cloud system 106. In the illustrated example, the users' names are displayed in as an alphabetized list in the user group portion 403, which is adjacent to the video portion 418, e.g., sidebar.

The names of active users (e.g., Adam, Brian, Chris, David) are displayed at normal color/contrast levels in user group portion 403. However, the names of inactive users (e.g., Ed and Frank) are grayed-out on the list and identified as “inactive.” The graying-out reduces the contrast, brightness, and/or color saturation to create a gray appearance and/or makes the inactive users' names appear less evident on the list. Additionally, the inactive users are relegated to the bottom of the list, in the illustrated example.

Of course, in other embodiments, other means of identifying the users are employed. For example in one case, simply a picture of the different active users is provided in place of the user names. In other embodiments, avatars or graphical representations of the different users represent them and provide information on the status of those users.

In still other examples, the list is located at other positions in the GUI 400.

Referring to FIG. 4B, after users log into the cloud system 106, their statuses as “inactive” are removed, they are displayed in normal color/contrast levels in the user group portion 403, and they are returned to their normal position in the alphabetized list. By way of example, user Ed switched from inactive to active between FIGS. 4A and 4B. Likewise, appearance of Ed's name is displayed at normal levels and is moved to his alphabetized position in the list.

In some embodiments, a text based message, sound effect, pop-up, or other warning is used to announce the arrival and/or status changes of the users.

In any event, when the designated start time is reached, then the video content data are displayed, i.e., played-back, in the video portion 418 on the user devices for those users that are logged on and members of the group.

As outlined previously, the video content data that are displayed in the video portions 418 of the GUIs 400 on each of the user devices 102-1 to 102-n are displayed in a synchronized fashion. Moreover, in one embodiment, when the controlling user pauses, skips forward/backward the playback or reproduction of the video content data on their controlling user device, these changes are propagated to the other user devices within the group.

Nevertheless, there are differences in how that video data are controlled and synchronized when the video data are from a live contemporaneous over the air broadcast of a television program, for example, or instead are from previously recorded video content data or video content data, e.g., on-demand movie, from third-party sources.

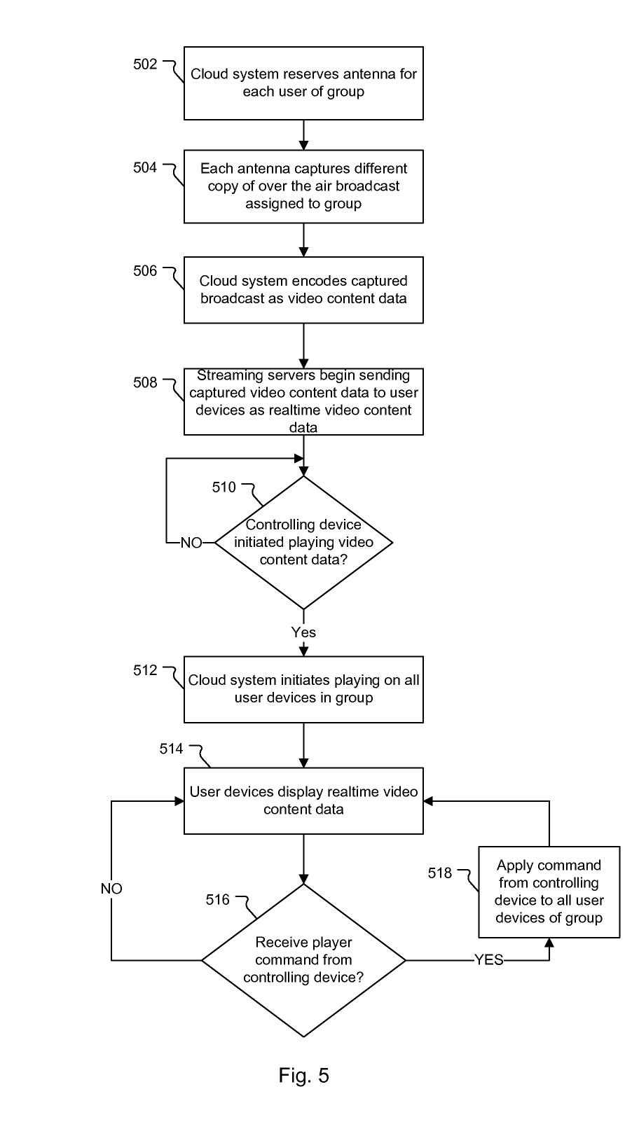

FIG. 5 is a flowchart illustrating how the cloud system 106 synchronizes the display of the video content data captured by antenna elements 108-1 to 108-n on the user devices 102-1 to 102-n of the group. The challenge here arises from the fact that each of the users of the group has their own separate video content data despite the fact that the video content data corresponds to the same broadcast television program, for example.

In the first step 502, the cloud system 106 reserves an antenna element 108-1 to 108-n for each user of the group. Next, each antenna element 108-1 to 108-n captures a different copy of the same over the air broadcast (i.e. television program) in step 504. The cloud system 106 transcodes the captured (or contemporaneous) broadcast from MPEG2 to MPEG4 encoding and thus as separate video content data streams for each of the users in step 506 and then stores the separate video content data streams as separate files in the broadcast file store 112. Each user has a separate file that holds the content data for that user despite the fact that each user is recording the same television program, for example. In the case of real time viewing by the group, the cloud system 106 also initiates the sending of the separate video content data to user devices as realtime video content data in step 508. Nevertheless, since the separate video content data for each of the different users was recorded with a common start time and shares a common time index provided by the cloud system 106, the playing of the video content data by of the separate users can be synchronized.

In the next step 510, the cloud system waits for a controlling device to initiate playing of the video content data in step 510. The controlling device is the user device which controls the playing of the video content data on the other user devices of the group. Generally, the organizing subscriber's user device is the controlling device by default, but any of the user devices of the group could be assigned or delegated to be the controlling device.

If the controlling device has initiated playing of the realtime video content data, then the cloud system 106 initiates playing on all the user devices of the group in step 512 by signaling the respective players on each of the other devices. In step 514, the user devices display the separate realtime video content data for each of the separate users synchronously among all of the devices in the group.

The cloud system 106 then determines if a player command has been received from the controlling device in step 516. Typical player commands include stop, play, pause, skip, record, and replay, to list a few examples. If no player commands are received, then the user devices continue to display the realtime video content data in step 514. If the cloud system 106 receives a player command from the controlling device, then the player command from the controlling device is applied to all the user devices of the group in step 518.

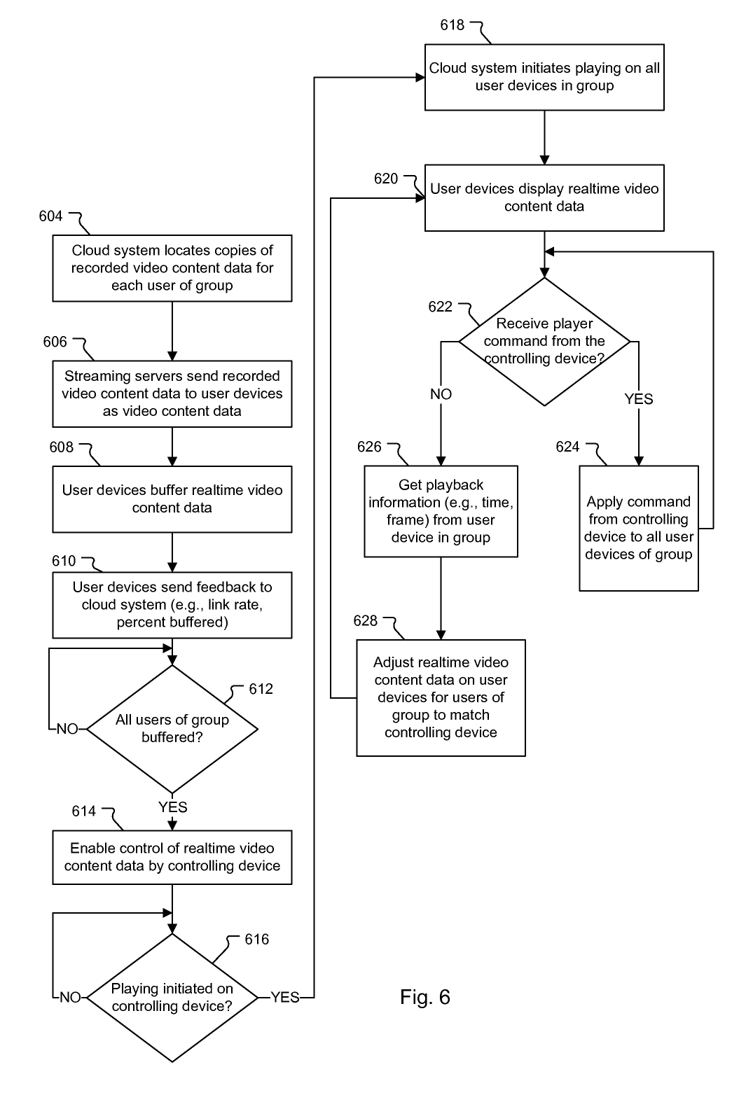

FIG. 6 is a flowchart illustrating how the cloud system 106 synchronizes separate copies of previously recorded video content data on the user devices 102-1 to 102-n of the group. This is addresses the situation where the group collects to watch a television program, for example, but do so in a time shifted manner. As result, the cloud system captures separate video content data each of the users for a designated television program, for example, and then stores that video content data into each of the separate user accounts in the broadcast file store 112 for later viewing at the scheduled time for the group.

In the first step 604, the cloud system 106 locates copies of the previously recorded video content data from the broadcast file store 112 in each of the different user accounts. For each user account, there is a different file containing video content data in the broadcast file store 112. Nevertheless, the video content data in each of these files is for the same television program.

The streaming servers 110-1 to 110-n then send the separate previously recorded video content data to the user devices of the group as video content data in step 606. The user devices 102-1 to 102-n buffer the video content data in step 608 and send feedback information to the cloud system 106 in step 610. This feedback information typically includes performance statistics such as link rate, network type, and what percentage of the video content data that have been buffered on the device, to list a few examples. The information further includes runtime or timestamp information that represents the amount of the program has been played-back on the device or the time for which the program has been played on the device accounting for pausing or rewinding, for example.

The feedback information is collected because the uses devices are often on different networks links with different connection speeds. Therefore, user devices with faster network connections are generally able to buffer a larger percentage of the video content data in a shorter amount of time. The feedback information enables the cloud system 106 to ensure that all the user devices are adequately buffered prior to playing the video content data. Additionally, in some embodiments, the cloud system may also force user devices to receive lower quality video content data in the case of a large disparity in the connection speeds among the user devices in the group.

In the next step 612, the cloud system waits until all the users of the group have buffered an adequate percentage of the video content data. In a typical implementation, the cloud system 106 analyzes the feedback information from the user devices to determine which user devices of the group have the slowest link rates and what percentage of the video content data needs to be buffered to reduce (or eliminate) interruptions during playback. While users with faster connections may be forced to wait the users with slower connections prior to playback, the cloud system is able to help ensure that all the users of the group share a similar viewing experience during social viewing and that the video plays-back in a synchronized fashion across the different devices.

Then the cloud system 106 enables playback control of the video content data by the controlling device in step 614. Next, the cloud system 106 waits for the controlling device to initiate playing of the video content data in step 616. If playing is initiated on the controlling device, then the cloud system 106 initiates playing on all the user devices 102-1 to 102-n of the group in step 618 by signaling the respective players on those devices. In the next step 620, the user devices display the playing video content data.

While the video content data are playing on the user devices, the cloud system 106 waits to receive a player command from the controlling device in step 622. Upon receiving a player command, the cloud system 106 applies the player command received from controlling device to the other user devices of the group in step 624.

If the cloud system 106 does not receive a player command, then the cloud system 106 obtains playback information from user devices in the group in step 626. The playback information typically includes the percentage of the video content data buffered and current video playback time or timestamp indicating the amount of video content data that has been played, to list a few examples. In the next step 628, the cloud system 106 adjusts the playback of the video content data of the user devices to synchronize the playback with the controlling device such as by skipping ahead or slowing the playback on specific devices in order to maintain synchronism in the playback among the user devices of the group.

In the previous examples, each of the users generally had different video content data that were generated by capturing over the air broadcasts from their separate antennas. Nevertheless, the video content data corresponded the same broadcast television program, for example. Thus, these separate video content data files could be streamed to the separate users and played in synchronism so that each of the users could watch the corresponding television program in the manner of a social viewing.

In other examples, the same video content data are in a sense duplicated and streamed to all the users of the group. This happens in situations where it is permissible for the organizing user to share their video content data, which was captured from the organizing user's antenna element, with the other users in the group. It also arises in the situation where the users of the group elect to watch third-party content such as purchased television programs or movies that are licensed to the cloud system 106, pay-per view movies or television program made available by the cloud system 106, or third-party/user-generated content that would be available from YouTube, LLC, for example, and accessed via the cloud system 106.

These situations are illustrated by the following to flow diagrams.

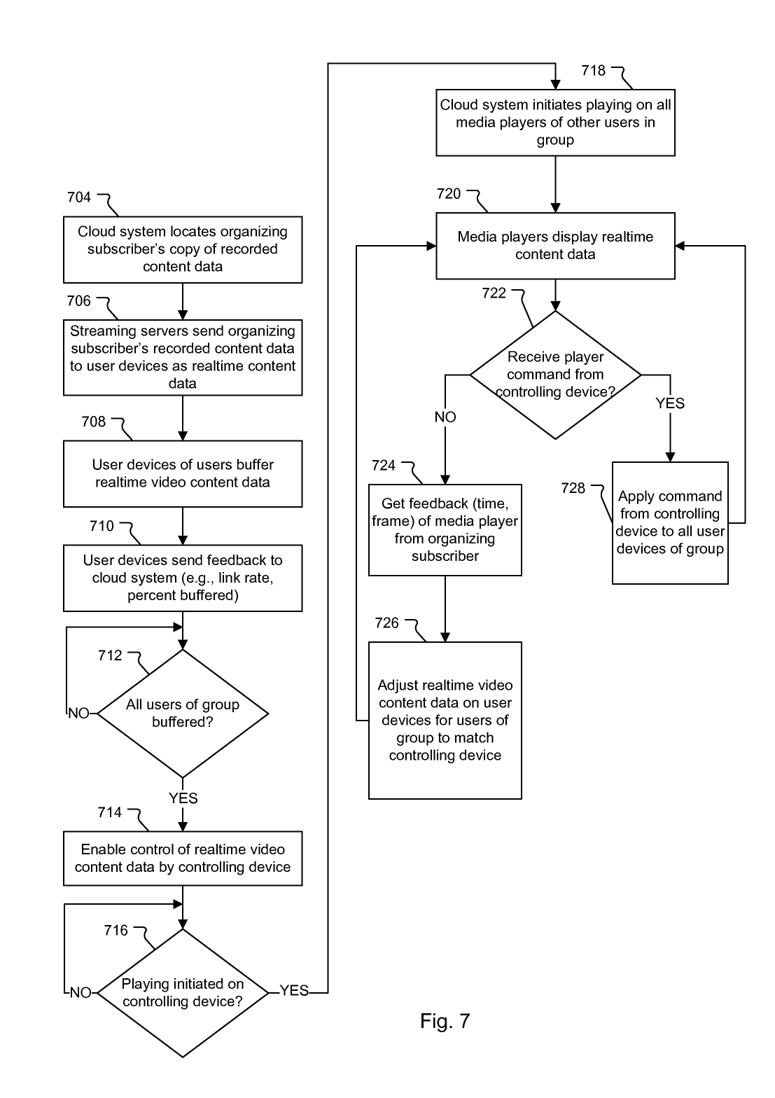

FIG. 7 is a flowchart illustrating how the cloud system 106 synchronizes the organizing subscriber's previously recorded video content data on the user devices 102-1 to 102-n of the group.

In the first step 704, the cloud system locates the organizing subscriber's previously recorded video content data in the broadcast file store 112. A similar step would be performed to access content stored in the online file store 114. The streaming servers 110-1 to 110-n then send the organizing subscriber's previously recorded or purchased content data to user devices 102-1 to 102-n as video content data in step 706.

The remaining steps 708-726 are identical steps 608-626, respectively, of FIG. 6. The process here, ever, is facilitated by the fact that each of the users is receiving the exact same video content data, which further facilitates the synchronization of its playing on each of the separate user devices.

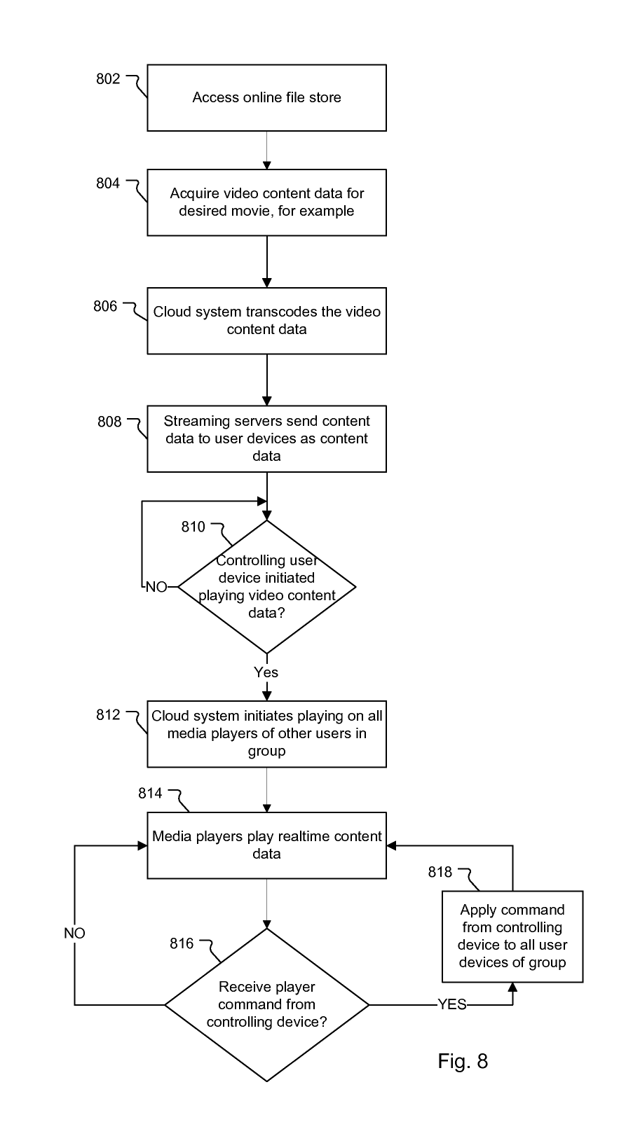

FIG. 8 is a flowchart illustrating how the cloud system 106 synchronizes video content data such as third-party content such as television programs or movies, pay-per view movies or television program, or user-generated content for the user devices 102-1 to 102-n of the group.

In step 802, the cloud system 106 accesses the video content data that are stored in the online file store 114 for example. This video content data may be resident in the online file store 114 or instead are accessed from a third-party content provider 120, for example. Once acquired in step 804, the content data are optionally transcoded into an encoding format compatible with the cloud system streaming servers in step 806. The organizing subscriber's antenna element then captures the over the air broadcast (i.e., video program) assigned to the group.

The remaining steps 808-818 are identical steps 506-518, respectively, of FIG. 5.

In the preferred embodiment, the cloud system 106 further includes the intra-group communication system 118. This functions to facilitate social viewing by allowing the users within the group to communicate with each other during the synchronized playing of the video content data on each of the respective separate user devices. It provides the option for the users to receive speech-to-text converted audio or optionally open up direct audio communications with one or more of the other users in the group.

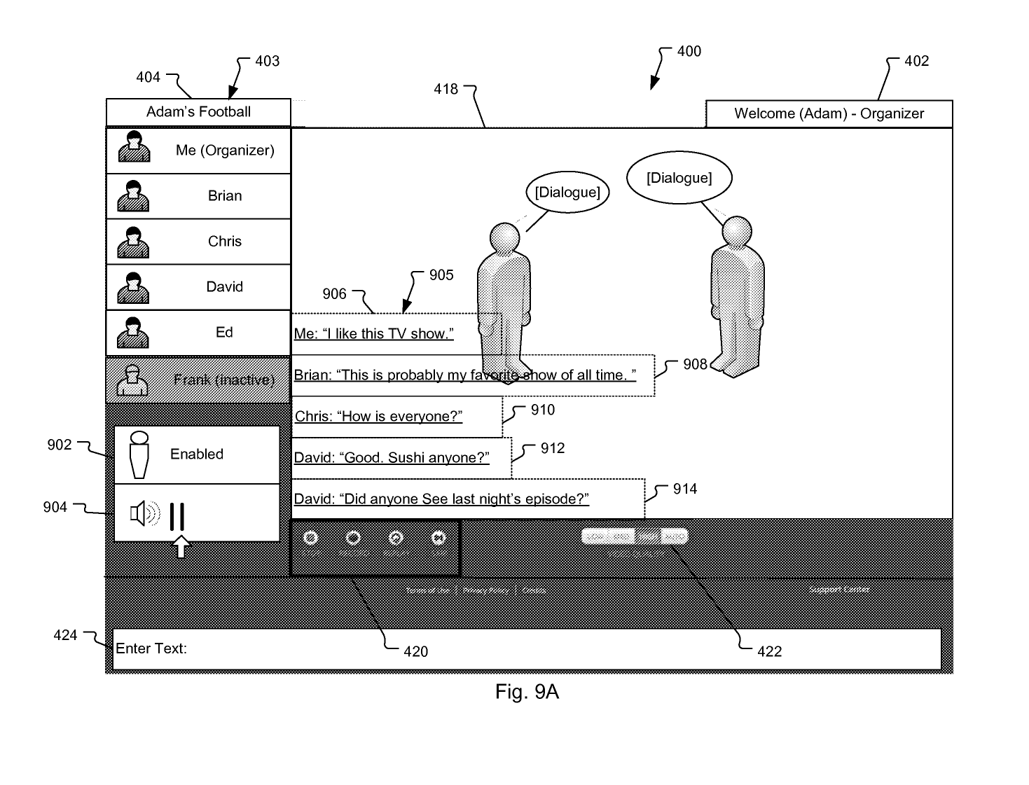

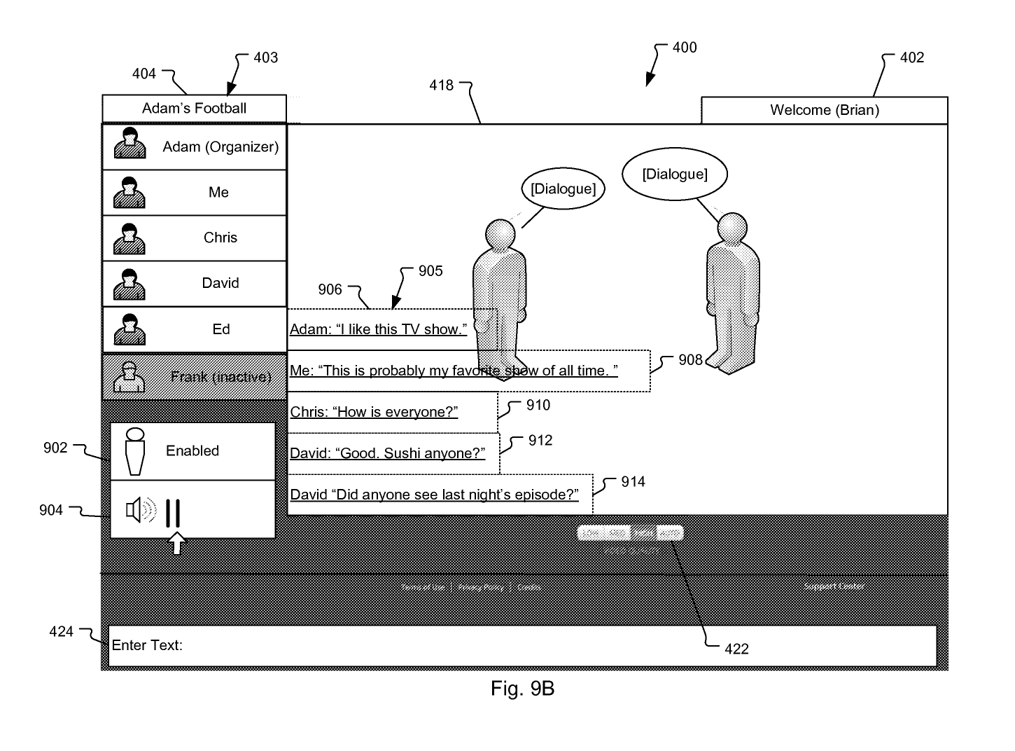

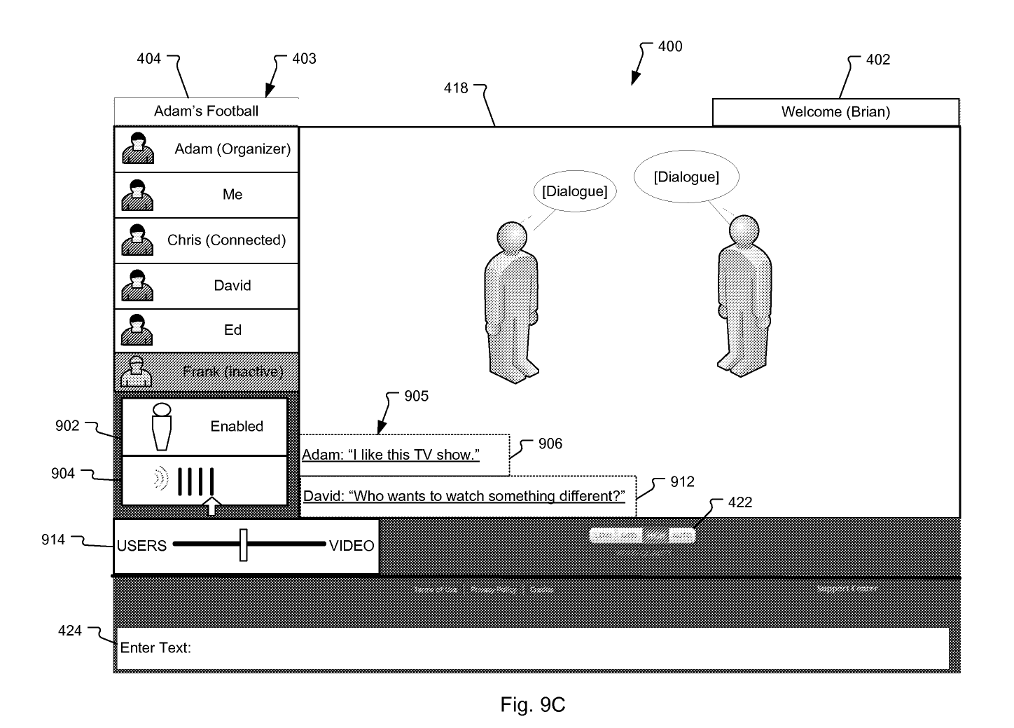

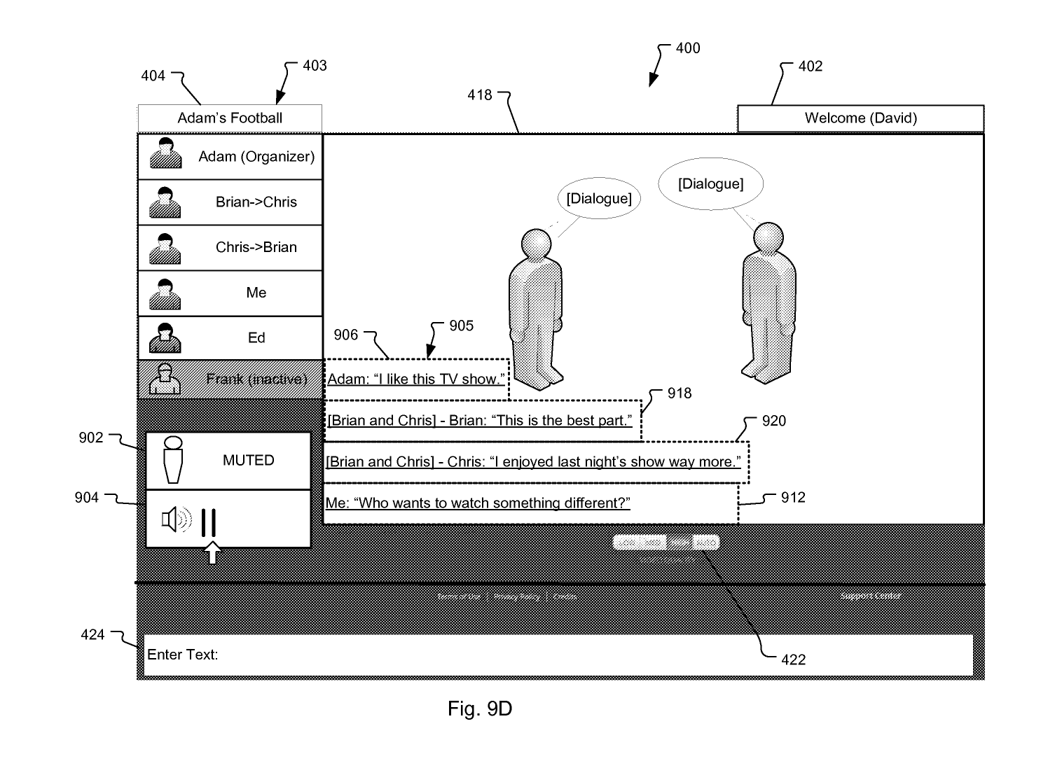

FIG. 9A illustrates an example of the graphical user interface 400 for the organizing subscriber of the group of users.

The graphical user interface 400 displays the user's name in the welcome portion 402. Because this user (Adam) is also the organizing subscriber, the title of “organizer” is also displayed in the welcome portion 402. In alternative embodiments, the users could be identified via alpha-numeric usernames. In these embodiments, the alphanumeric usernames are displayed to other users of the group, but user's name would still be displayed in the welcome portion 402. In still other examples, other modalities for identifying the different users to the group are employed such as avatars or other graphics.

In the illustrated example, the video portion 418 displays the video content data sent from the cloud system 106 that is being played and speech to text communications 906, 908, 910, 912, 914 in the speech to text portion 905.

In a typical implementation, the speech to text communications 906, 908, 910, 912, 914 are displayed in the video portion 418 and overlaid upon the playing video content data. The illustrated example shows the speech to text communications 906, 908, 910, 912, 914 separated by user and each successive communication is displayed above the previous communication until with the communications scrolling downward until they disappears off of the text portion 905.

This is of course only one embodiment. In an alternative embodiment, the speech to text communications are displayed with a ticker (also known as a slide or crawler). The ticker scrolls along the bottom (or top) of the video portion 418 from right to left and each successive communication is displayed after the previous communication.

In still other examples, the speech to text communications 906, 908, 910, 912, 914 are displayed in other regions of the GUI 400 and specifically outside of the video portion 418.

In the illustrated example, the speech to text communications 906, 908, 910, 912, 914 are selectable hyperlinks. Selecting one of the speech to text communications enables the selecting user to open (or initiate) a connection with user who generated the communication.

For example, in one embodiment, if the current user, Adam wishes to speak directly to another user such as Brian, then Adam would click on Brian's speech to text communication 908. In another example, Adam would click on Brian's name in the list 404.

Upon connecting with other users, the user device of the selecting user is able to reproduce audio detected by the user devices of the selected users. Specifically, using the previous example, when Adam selects Brian, then the microphone for Brian's user device 102-2 detects Brian's speech, then encodes that speech and then transmits it to Adam's user device 102-1. This can happen either directly via a peer-to-peer connection or via the intra-group communication system 118 of the cloud system 106.

Adam's user device 102-1 receives Brian's encoded speech and then reproduces that speech via its speaker. Simultaneously, the microphone on Adam's user device 102-1 detects Adam speech, that speech is encoded by Adam's user device 102-1 and then transmitted to Brian's user device 102-2, where it is reproduced by the speaker in Brian's user device 102-2.

In the preferred embodiment, the connections are “two-way” connections that allow each of the connected users to hear the audio generated by the other users.

In an alternative embodiment, the connections with other users are “one-way” connections. That is, the selecting user is able to hear the audio generated by the selected users, but the selected users are not able hear the selecting user.

The user group portion 403 is typically displayed as a list adjacent to the video portion 418 and includes the group name portion 404. Similar to the speech to text communications, the list of users in the user group portion 403 are selectable by the other users to initiate connections. The inactive users (e.g., Frank), however, are not selectable.

The GUI 400 displayed on the controlling device (typically the organizing user) includes video player controls 420, which enable the controlling device to control the play back of the video content data on the user devices in the group. In the illustrated example, the video player controls 420 include stop/start, record, replay, and skip. Alternative embodiments, could include additional player controls such as pause, skip backward, or resume (a partially completed program), for example.

The GUI 400 further includes a microphone control 902, volume control 904, and video quality selector 422. Unlike the player commands from the controlling device that are applied to the other user devices in the group, these controls are not applied to other devices in the group but only control the local player. Each user is able to control their own volume, microphone, and video quality for their device.

Lastly, the illustrated example further includes a text field 424 that allows users to manually enter text because some user devices do not have microphones and/or the users are someplace where generating audio (i.e., speaking) is not feasible or appropriate.

FIG. 9B illustrates an example of the graphical user interface 400 displayed for the users of the group who are not the controlling user.

In general, the functionality of the GUI 400 is the same as previously described. However, the GUI 400 for other users of the group does not include player controls (e.g., ref numeral 420 in FIG. 9A). The player controls are not provided because the viewing is synchronized in this social viewing mode. Thus, these player controls are in effect delegated to the controlling user. The illustrated example shows the user interface displayed on the user device of user Brian. Thus, the welcome portion 402 displays Brian's name and his speech to text communications are identified with the identifier “Me.”

FIG. 9C illustrates an example of the GUI 400 displayed for connected users.

Upon connecting with another user, a status of “connected” is displayed next to the user in the user group portion 403. Additionally, the connected status is displayed in the user group portion 403.

When two or more users are connected, the speech to text communications of those users are not displayed in the user's respective GUIs. Thus, there are speech to text communications for users Brian and Chris in the illustrated example. On the other hand, Adam does not see the speech to text converted information from Chris, to which he has established an audio connection.

However, other users will be able to view speech to text communications of combined audio (shown in FIG. 9D) of Adam and Chris. In an alternative embodiment, the speech to text communications are shown when users are connected.

A mixing control (e.g., a crossfader) 914 is displayed when users are connected and have established an audio connection. This mixing control 914 allows the users to control and combine audio detected by users and audio associated with video content data playback. The mixing control 914 allows each user to maintain a constant volume of their user device, while also controlling the volume (via fading) of audio from video content data and audio generated by the users. In this way, when users have established an audio connection with another user, they can control the relative volume of the audio connection relative to the audio of the video content data.

FIG. 9D illustrates an example of a graphical user interface displayed for the users of the group when other users are connected and have established an audio connection between them.

By way of example, user David is not audio-connected to any other users, but users Brian and Chris have established an audio connection between them. The connection between users Brian and Chris is indicated in the user group portion 403. Additionally, the speech to text communications generated by users Brian and Chris (ref numerals 918 and 920, respectively) are grouped together, but still identifies the speaking user.

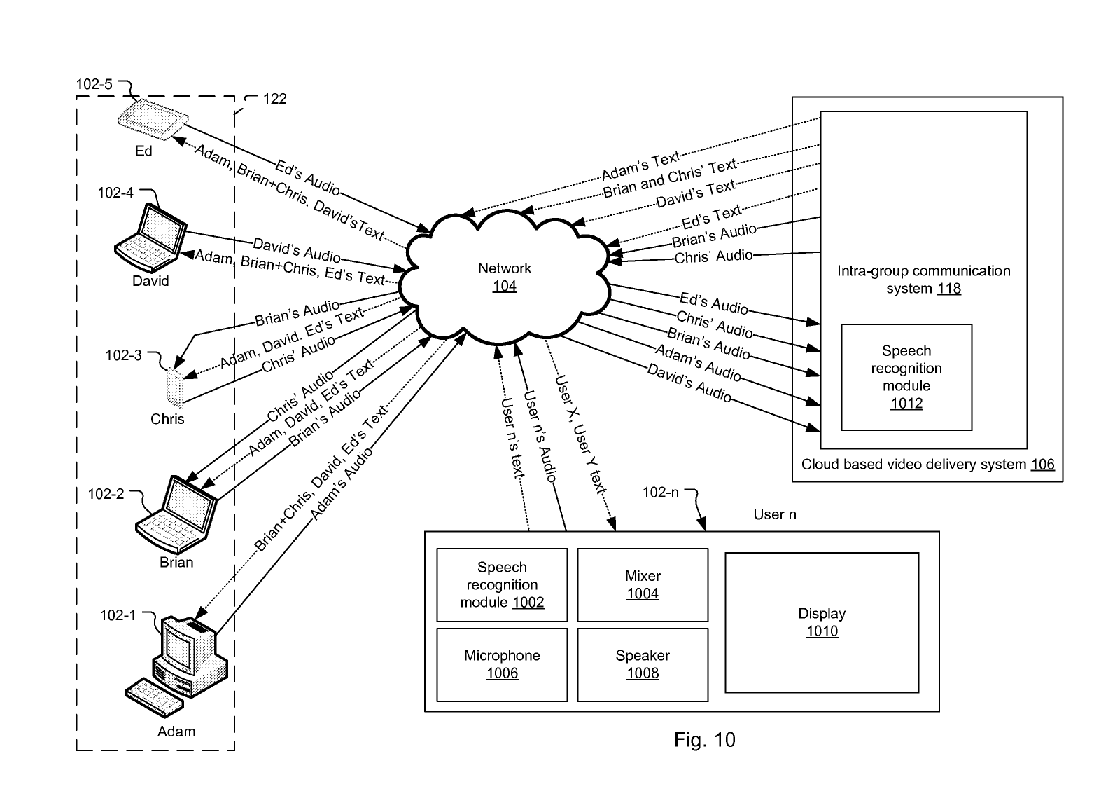

FIG. 10 is a block diagram illustrating the cloud based video delivery system 106 and how audio generated by the users is converted into speech to text communications and then distributed by the intra-group communication system 118.

The user devices 102-1 to 102-n detect audio generated by the users (Adam, Brian, Chris, David, and Ed), which is then sent via the network 104 to the cloud system 106. The arrows labeled Adam's Audio, Brian's Audio, Chris' Audio, David's Audio, and Ed's Audio represent the detected audio from the microphones of the user devices 102-1 to 102-n that is being sent to the intra-group communication system 118 of the cloud system 106.

The audio is converted into speech to text communications by a speech recognition module 1012 of the intra-group communication system 118. In a typical implementation, the speech recognition module 1012 utilizes speech recognition software, which translates speech into text and is able to identify the users by the sound of their voice in some examples. Additionally, the speech recognition software is able to further analyze the audio (e.g., recognize speech patterns, accents, and voice inflections) of the users to yield more accurate speech to text translations over time. The speech to text communications are then distributed to the user devices 102-1 to 102-n by the intra-group communication system 118. This is typically performed as a separate data feed aside from the video content data that are being streamed by the streaming servers to the same user devices.

In the illustrated example, user device 102-1 (user Adam) receives speech to text communications from users Brian+Chris (i.e., connected users), David, and Ed. User device 102-4 (i.e., user David) receives speech to text communications of users Adam, Brian+Chris, and Ed. Likewise, user device 102-5 (i.e., user Ed) receives speech to text communications of users Adam, Brian+Chris, and David.

If users are connected, then they will also receive the audio data generated by the users to which they are connected. Thus, user device 102-2 (user Brian) receives the audio generated from user Chris and speech to text communications from users Adam, David and Ed. Similarly, user device 102-3 (user Chris) receives the audio data generated from user Brian and speech to text communications of users Adam, David and Ed.

In the illustrated example, user device 102-n (User n) represents an exemplary user device. The user device 102-n is shown as a block diagram to further illustrate the components of the user device, which as are also typical components of the other user devices.

The exemplary user device 102-n includes a display 1010 to display realtime video content data and speech to text communications. The device 102-n further includes at least one microphone 1006 and at least one speaker 1008 for detecting and reproducing audio, respectively. A mixer 1004 enables the device to combine the audio generated by users with the audio of the video content data.

The user device 102-n also includes a speech recognition module 1002, which enables speech to text conversion to be performed by the user device, according to one implementation. The arrow labeled User n's text represent the speech to text conversion performed by User n's device 102-n.

Performing the speech to text conversion on the user devices reduces the computing and processing for the speech to text module 119 of the intra-group communication system 118. In a typical implementation, some of the speech to text conversions would be performed by speech to text module of the user devices and some would be performed by the speech to text module 119 of the intra-group communication system 118 depending on the available computing resources on each user device.

Generally, the user devices 102-1 to 102-n also include many additional components, which are not shown in the figures. For example the user devices typically include a central processing unit, an operating system, memory, storage systems, network interface controllers, and application software, to list a few examples.

While this invention has been particularly shown and described with references to preferred embodiments thereof, it will be understood by those skilled in the art that various changes in form and details may be made therein without departing from the scope of the invention encompassed by the appended claims.

What is claimed is:

1. A cloud based video delivery system for streaming video content data of a television program to a group of users, the system comprising:
a file store for storing the content data of the television program as separate files for each of the users;
a streaming server system that sends each user their respective content data and synchronizes the video content data playback for the users within the group; and
user devices that play the video content data received from the streaming server system.

2. The system according to claim 1, wherein the streaming server synchronizes the playback of the video content data on the user devices in response to a controlling user device for the group.

3. The system according to claim 1, wherein the video content data are encoded over the air broadcasts captured by antenna elements of the cloud based video delivery system.

4. The system according to claim 1, wherein the video content data are obtained from third party content providers.

5. The system according to claim 1, wherein the video content data are previously recorded over the air broadcasts.

6. The system according to claim 5, wherein the streaming server system verifies that the user devices of the group have buffered content data on the user devices before enabling the controlling user device to control playback of the video content data.

7. A system for displaying intra-group communications and streaming video content data, the system comprising:
user devices for displaying the video content data along with speech-to-text communications;
a streaming server system that streams the video content data to the user devices; and
an intra-group system that distributes the speech-to-text or audio communications based on user selection, the speech-to-text or audio communications being generated from the audio detected by the user devices, the speech-to-text or audio communications being distributed between the user devices that are within a group.

8. The system according to claim 7, wherein the speech-to-text communications are generated by a speech to text module of the intra-group system.

9. The system according to claim 7, wherein the speech-to-text communications are generated by speech to text modules of the user devices.

10. The system according to claim 7, wherein the intra-group system distributes the audio detected by the microphones to at least some of the user devices in the group.

11. The system according to claim 7, wherein the user devices further include a mixer control a combination of the audio communications and audio associated with the streaming video content data.

12. A method social viewing of video programs, the method comprising:
enabling users to create respective groups of users;
enabling the users to assign video programs and/or timeslots to their respective groups;
capturing and encoding the video programs as video content data; and
enabling the users to control synchronized playback of the video content data for the video programs and/or timeslots on the user devices within their respective groups of users.

13. The method according to claim 12, further comprising enabling non-subscribing users to create accounts to access the video content data of their respective groups.

14. The method according to claim 12, further comprising determining which users of the respective groups have logged on and sending messages to users that have not logged in.

15. A graphical user interface displayed on a user device of a cloud based video delivery system comprising:
a video portion of the graphical user interface in which streaming video content data are displayed;
a user group portion that identifies users within a group; and
a speech to text portion that displays speech to text converted audio of the users within the group.

16. The graphical user interface of claim 15, further comprising a mixer control that enables a user of the user device to control reproduction of audio associated the video content data and audio detected by users devices of users within the group.

17. The graphical user interface of claim 15, wherein the speech-to-text communications are displayed within the video portion of the graphical user interface along with video content data.

18. The graphical user interface of claim 15, wherein the speech-to-text communications are selectable to cause the user device to reproduce audio detected by the user devices of the selected users.

19. A method for streaming video content data to group of users, the method comprising:
synchronizing the video content data playing on user devices of the other users within the group in response to the received commands, the video content data originating from different files but being for the same television program; and
displaying the synchronized video content data on the user devices of the group.

20. The method according to claim 19, wherein the video content data are encoded over the air broadcasts captured by different antenna elements of a cloud based video delivery system.

21. The method according to claim 20, further comprising verifying that the user devices of the group have buffered video content data before enabling a controlling user device to control playback of the video content data.

22. A method of displaying intra-group communications and streaming video content data, the method comprising:
detecting audio generated by users at the user devices;
converting the detected audio into speech-to-text communications;
distributing the speech-to-text communications between the user devices that are within a group;
streaming the video content data to the user devices within the group; and
displaying the video content data along with speech-to-text communications on user devices.

23. The method according to claim 22, wherein the speech-to-text communications are generated by a speech to text module of a cloud based video delivery system.

24. The method according to claim 22, wherein the speech-to-text communications are generated by speech to text modules of the user devices.

25. The method according to claim 22, further comprising distributing the audio detected by the user devices to at least some of the other user devices.

26. The method according to claim 25, further comprising combining and preproducing the audio detected by the microphones and audio associated with the video content data.

27. The method according to claim 22, further comprising labeling the speech-to-text communications of each user.
